(19) United States
(12) Patent Application Publication
(10) Pub. No.: US 2017/0034336 A1
(43) Pub. Date: Feb. 2, 2017

(54) EVENT PROMPTING METHOD AND DEVICE

(71) Applicant: Xiaomi Inc., Beijing (CN)

(72) Inventors: Kangxi TAN, Beijing (CN); Li HE, Beijing (CN); Weixing LIU, Beijing (CN)

(73) Assignee: Xiaomi Inc.

(21) Appl. No.: 15/179,276

(22) Filed: Jun. 10, 2016

(30) Foreign Application Priority Data
Jul. 30, 2015 (CN) 201510461271.1

(51) Int. Cl. H04M 1/725; H04M 3/42; H04W 8/18; H04M 1/60; H04L 12/58

(52) U.S. Cl. CPC H04M 1/72558; H04M 1/6066; H04L 51/24; H04M 1/7253; H04W 8/183; H04M 3/42059

(57) ABSTRACT

An event prompting method for use in a terminal includes judging whether the terminal is playing predetermined audio information via a wireless headphone connected with the terminal when an event to be prompted is received, and sending a silent prompt command to the wireless headphone according to the event to be prompted if the terminal is playing the predetermined audio information. The silent prompt command is configured to control the wireless headphone to perform a silent prompt operation.

### CROSS-REFERENCE TO RELATED APPLICATIONS

This application is based upon and claims the benefit of priority to Chinese Patent Application No. 201510461271.1, filed on Jul. 30, 2015, the entire contents of which are incorporated herein by reference.

### TECHNICAL FIELD

The present disclosure relates to terminal technology and, more particularly, to an event prompting method and event prompting device.

### BACKGROUND

When a user of a terminal device is listening to a song via a Bluetooth headphone, if the terminal receives, for example, an incoming call or an instant communication message, the terminal device will interrupt the song and perform a corresponding ringing prompt operation. For example, when the terminal receives a short message, the song will pause, and a prompt sound for the short message will be made, and then the song continues to play. Thus, when an event to be prompted is received, song playing will be interrupted, and a prompt sound corresponding to the event to be prompted will be played. As such, the user cannot enjoy the song without interruption.

### SUMMARY

In accordance with the present disclosure, there is provided an event prompting method for use in a terminal. The method includes judging whether the terminal is playing predetermined audio information via a wireless headphone connected with the terminal when an event to be prompted is received, and sending a silent prompt command to the wireless headphone according to the event to be prompted if the terminal is playing the predetermined audio information. The silent prompt command is configured to control the wireless headphone to perform a silent prompt operation.

Also in accordance with the present disclosure, there is provided an event prompting method for use in a wireless headphone. The method includes receiving a silent prompt command from a terminal connected with the wireless headphone and performing a silent prompt operation corresponding to the silent prompt command.

Also in accordance with the present disclosure, there is provided an terminal including a processor and a memory storing instructions that, when executed by the processor, cause the processor to judge whether the terminal is playing predetermined audio information via a wireless headphone connected with the terminal when an event to be prompted is received, and send a silent prompt command to the wireless headphone according to the event to be prompted if the terminal is playing the predetermined audio information. The silent prompt command is configured to control the wireless headphone to perform a silent prompt operation.

It is to be understood that both the foregoing general description and the following detailed description are illustrative and explanatory only and are not restrictive of the disclosure, as claimed.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 is a flow chart showing an event prompting method according to an exemplary embodiment.

FIG. 2 is a flow chart showing an exemplary detailed process of S102 in FIG. 1.

FIG. 3 is a flow chart showing an exemplary detailed process of S201 in FIG. 2.

FIG. 4 is a flow chart showing an event prompting method according to another exemplary embodiment.

FIG. 5 is a flow chart showing an event prompting method according to another exemplary embodiment.

FIG. 6A is a flow chart showing an event prompting method according to another exemplary embodiment.

FIG. 6B is a flow chart showing an event prompting method according to another exemplary embodiment.

FIG. 7 is a flow chart showing an event prompting method according to another exemplary embodiment.

FIG. 8 is a flow chart showing an exemplary detailed process of S702 in FIG. 7.

FIG. 9 is a flow chart showing an identity obtaining method according to an exemplary embodiment.

FIG. 10 is a block diagram showing an event prompting device according to an exemplary embodiment.

FIG. 11 is a block diagram showing an example of the sending module in the event prompting device shown in FIG. 11.

FIG. 12 is a block diagram showing an event prompting device according to another exemplary embodiment.

FIG. 13A is a block diagram showing an event prompting device according to another exemplary embodiment.

FIG. 13B is a block diagram showing an example of the second judging module in the event prompting device shown in FIG. 13A.

FIG. 14 is a block diagram showing an example of the obtaining module in the event prompting device shown in FIG. 13A.

FIG. 15 is a block diagram showing an event prompting device according to another exemplary embodiment.

FIG. 16 is a block diagram showing an example of the performing module in the event prompting device shown in FIG. 15.

FIG. 17 is a block diagram showing an event prompting device according to another exemplary embodiment.

FIG. 18 is a block diagram showing an event prompting device according to another exemplary embodiment.

### DETAILED DESCRIPTION

Reference will now be made in detail to illustrative embodiments, examples of which are illustrated in the accompanying drawings. The following description refers to the accompanying drawings in which the same numbers in different drawings represent the same or similar elements unless otherwise represented. The implementations set forth in the following description of illustrative embodiments do not represent all implementations consistent with the disclosure. Instead, they are merely examples of apparatuses and methods consistent with aspects related to the disclosure as recited in the appended claims.

FIG. 1 is a flow chart showing an event prompting method 100 according to an exemplary embodiment. The method can be used, for example, in a terminal on which event prompting needs to be performed. As shown in FIG. 1, at S101, it is judged whether the terminal is playing predetermined audio information via a wireless headphone connected with the terminal when an event to be prompted is received. At S102, a silent prompt command is sent to the wireless headphone according to the event to be prompted if the terminal is playing the predetermined audio information via the wireless headphone connected with the terminal. The silent prompt command is configured to control the wireless headphone to perform a silent prompt operation.

The wireless headphone herein refers to a headphone that can be connected with the terminal without a cable. For example, the wireless headphone can be a Bluetooth headphone, an infrared headphone, etc. The event to be prompted includes an event for which a prompt may need to be performed to inform a user of the terminal of the occurrence of the event. The predetermined audio information can be preset by the user or a manufacturer. For example, the predetermined audio information can include the user's favorite songs or videos. According to the present disclosure, the silent prompt operation refers to a prompt operation that does not make a sound. The silent prompt operation can be, for example, a vibration prompt operation or a light flashing prompt operation.

Thus, according to the present disclosure, when a prompt operation needs to be performed while predetermined audio information is being played, a silent prompt operation, instead of a sound prompt operation, is performed. As such, the user's enjoyment of the predetermined audio information will not be interrupted and the user experience is improved.

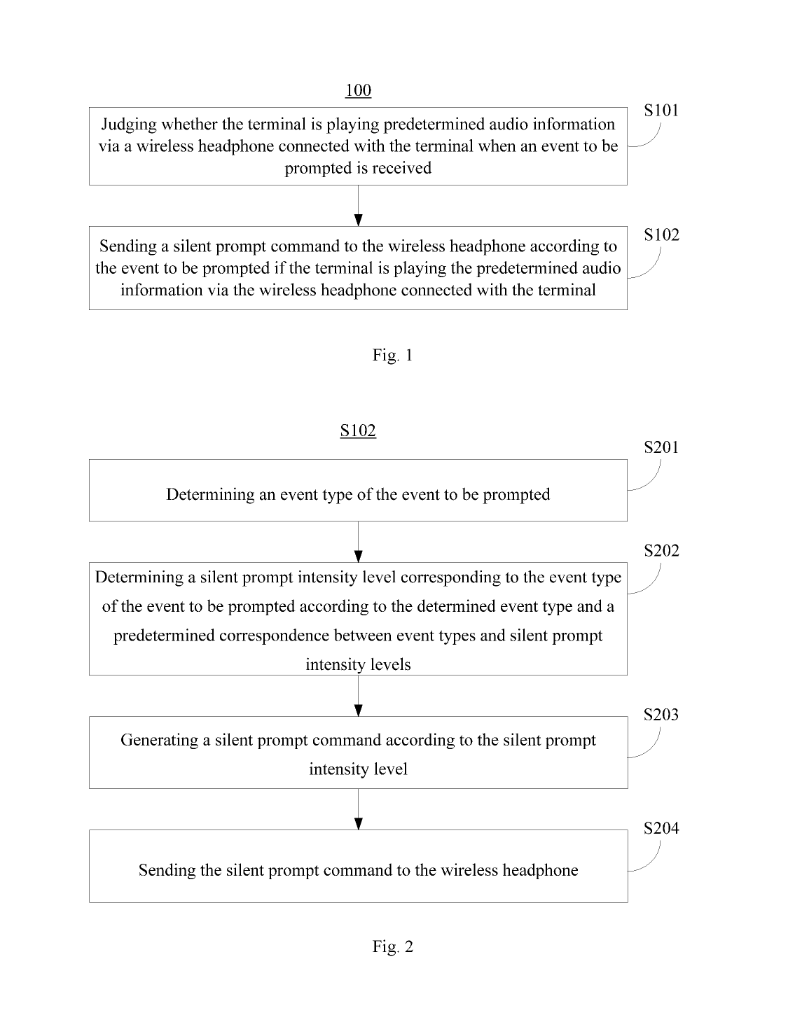

FIG. 2 shows an exemplary detailed process of S102 in FIG. 1. As shown in FIG. 2, at S201, a type of the event to be prompted is determined. According to the events to be prompted, the type, which is also referred to herein as an “event type,” can include, for example, a message prompt type, e.g., a short message prompt type or an instant communication message prompt type, a system music playing type, or a system video playing type.

At S202, a silent prompt intensity level corresponding to the type of the event to be prompted is determined according to the type of the event to be prompted and a predetermined correspondence between event types and silent prompt intensity levels.

In some embodiments, the correspondence can be set according to a received setting command. The silent prompt intensity levels can include, for example, level 1 to level 3. The higher the silent prompt intensity level is, the higher is the prompt intensity. The prompt intensity can be, for example, a vibration intensity, a vibration frequency, a flicker brightness, or a flicker frequency. For example, an incoming call generally indicates an urgent matter, so the corresponding silent prompt intensity level can be set to, e.g., level 3. On the other hand, an instant communication message is generally less urgent than an incoming call, so the corresponding silent prompt intensity level can be set to, e.g., level 1. Thus, when the silent prompt command received by the wireless headphone is an incoming call prompt and the corresponding silent prompt intensity level is level 3, the silent prompt operation can be performed with a level-3 vibration intensity or a level-3 light flashing prompt intensity. When the silent prompt command received by the wireless headphone is an instant communication message prompt and the corresponding silent prompt intensity level is level 1, the silent prompt operation can be performed with a level-1 vibration prompt intensity or a level-1 light flashing prompt intensity.

At S203, the silent prompt command is generated according to the silent prompt intensity level. At S204, the silent prompt command is sent to the wireless headphone. The wireless headphone is configured to perform the silent prompt operation according to the silent prompt intensity level in the silent prompt command.

Thus, according to the present disclosure, the level of prompt intensity can be set according to the type of the event to be prompted such that the user can determine whether to immediately act on the event according to the level of prompt intensity. As such, the user will not miss important events.

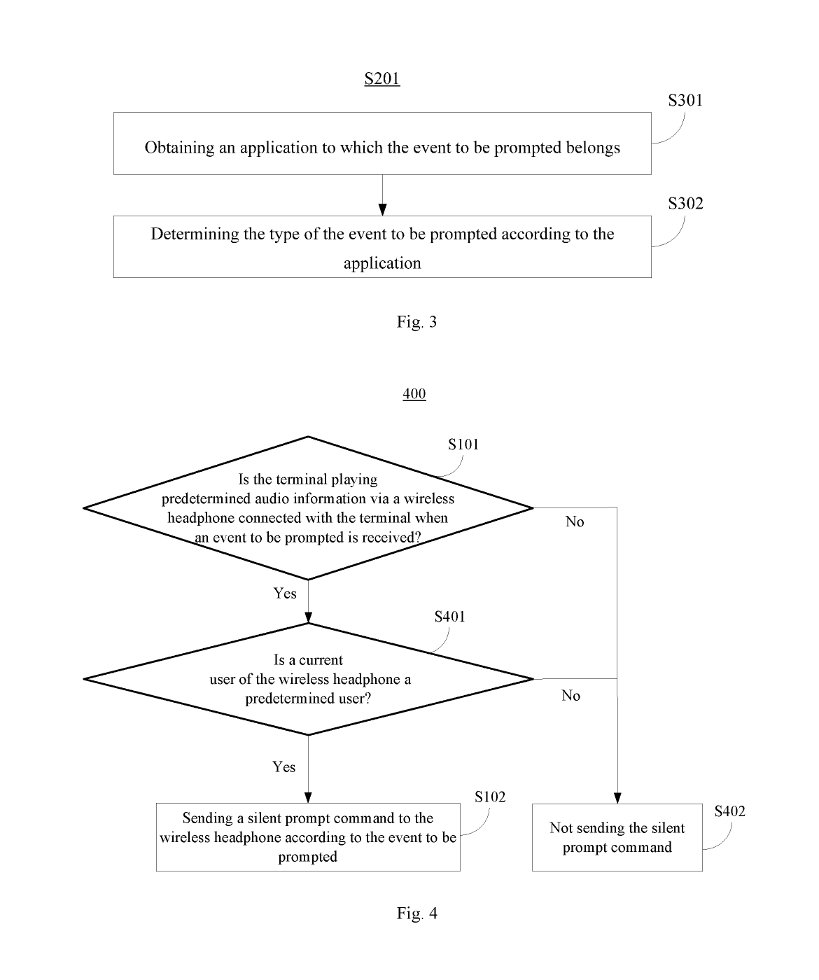

FIG. 3 shows an exemplary detailed process of S201 in FIG. 2. As shown in FIG. 3, at S301, an application to which the event to be prompted belongs is obtained. At S302, the type of the event to be prompted is determined according to the application.

For example, when the application to which the event to be prompted belongs is a phone application, the type of the event to be prompted can be an incoming call prompt. When the application to which the event to be prompted belongs is a short message application, instant communication software, etc., the type of the event to be prompted can be an instant communication message type. When the application to which the event to be prompted belongs is a multimedia application, the type of the event to be prompted can be a system sound/video playing type.

FIG. 4 is a flow chart showing an event prompting method 400 according to another exemplary embodiment. The method 400 is similar to the method 100, except that in the method 400, before sending the silent prompt command to the wireless headphone according to the event to be prompted, i.e., S102 in methods 100 and 400, it is judged whether a current user of the wireless headphone is a predetermined user (S401). If the current user is the predetermined user (S401: Yes), S102 is executed. If the current user is not the predetermined user (S401: No), no silent prompt command is sent to the wireless headphone (S402). For example, an owner of the terminal can be set as the predetermined user. Thus, after the terminal receives the event to be prompted, the terminal judges whether the current user of the wireless headphone is the owner of the terminal. If the current user is the owner, the terminal sends the silent prompt command to the wireless headphone to prompt the owner. On the other hand, if the current user is not the owner, the terminal does not need to process the event to be prompted, and thus does not send the silent prompt command to the wireless headphone, i.e., no prompt is performed.

In the example shown in FIG. 4, S401 is executed after S101. In some embodiments, S401 can be executed before S101. That is, when an event to be prompted is received, it is first judged whether the current user is the predetermined user. If the current user is the predetermined user, then it is further judged whether the terminal is playing the predetermined audio information. If the current user is not the predetermined user, then no further action is performed.

Thus, according to the present disclosure, it is ensured that the owner would not miss the prompt, and a non-owner can listen to the predetermined audio information normally. As such, the user experience is further enhanced.

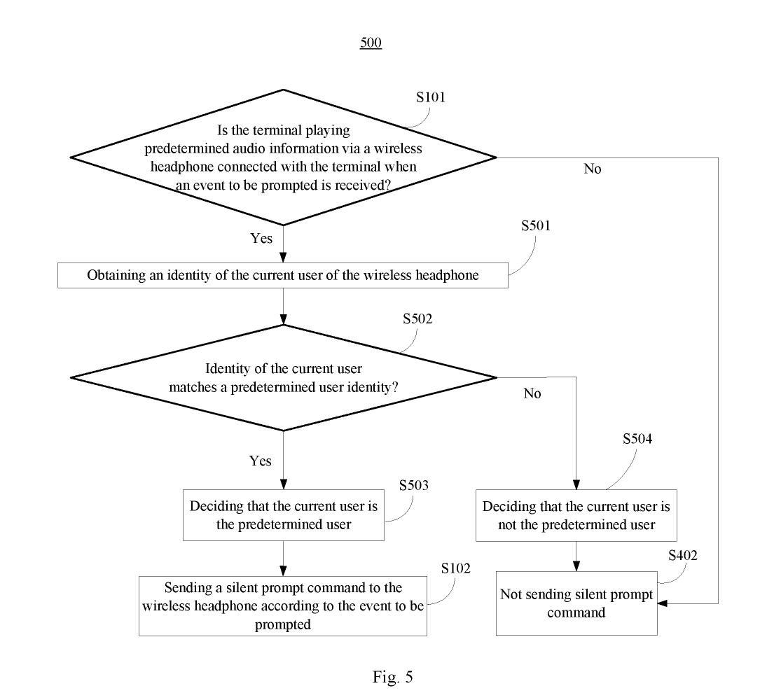

FIG. 5 is a flow chart showing an event prompting method 500 according to another exemplary embodiment. The method 500 is similar to the method 400, but includes a detailed process for determining whether the current user of the wireless headphone is the predetermined user.

As shown in FIG. 5, at S501, an identity of the current user of the wireless headphone is obtained. At S502, it is judged whether the identity of the current user matches a predetermined user identity. If the identity of the current user matches the predetermined user identity (S502: Yes), it is decided that the current user is the predetermined user (S503). If the identity of the current user does not match the predetermined user identity (S502: No), it is decided that the current user is not the predetermined user (S504).

In the example shown in FIG. 5, S101 is executed before S501. In some embodiments, S101 can be, for example, after S503. That is, when the event to be prompted is received, it is first judged whether the terminal is playing the predetermined audio information, and if so, a silent prompt command is sent.

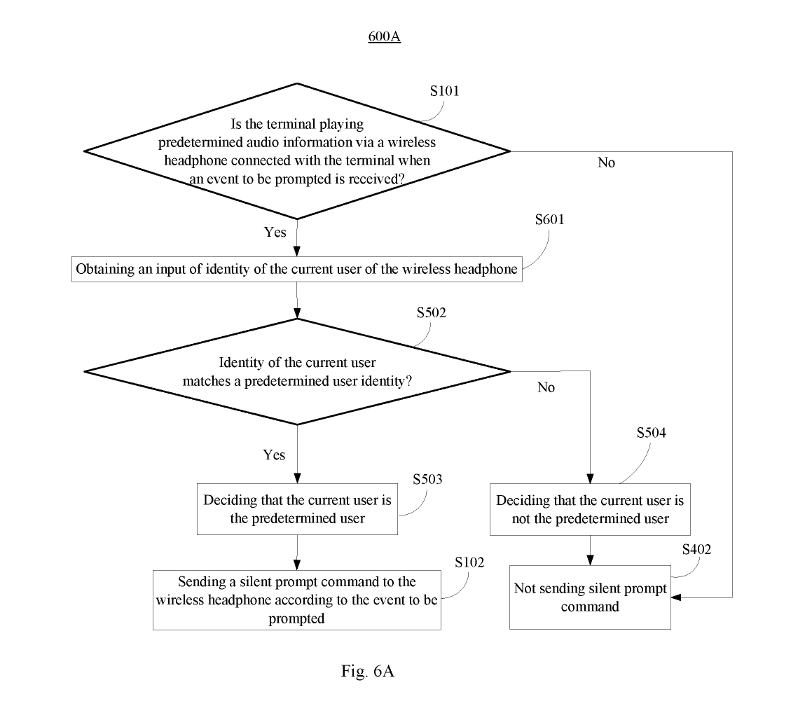

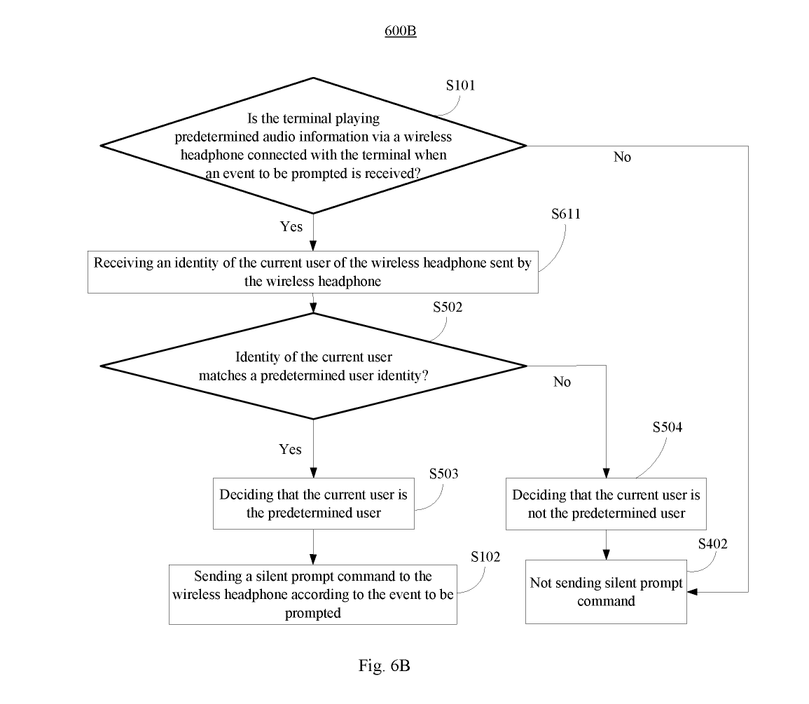

FIGS. 6A and 6B are flow charts showing event prompting methods 600A and 600B according to other exemplary embodiments. The methods 600A and 600B are similar to the method 500, except that in the method 600A, the identity of the current user of the wireless headphone is input by the user (S601), while in the method 600B, the identity of the current user of the wireless headphone is received from the wireless headphone (S611).

In some embodiments, an interface is provided on the terminal, and the user can input the identity thereof in the interface. In some embodiments, the terminal can obtain the identity of the current user from the wireless headphone. According to the present disclosure, the terminal can also obtain the identity of the current user in other ways. For example, a head photo of the current user can be taken and compared with a head photo of the predetermined user. If the head photo of the current user matches the head photo of the predetermined user, the current user is decided to be the predetermined user. Otherwise, the current user is decided not to be the predetermined user. Alternatively, fingerprint information of the current user can be obtained and compared with fingerprint information of the predetermined user. If the fingerprint information of the current user matches the fingerprint information of the predetermined user, the current user is decided to be the predetermined user. Otherwise, the current user is decided not to be the predetermined user.

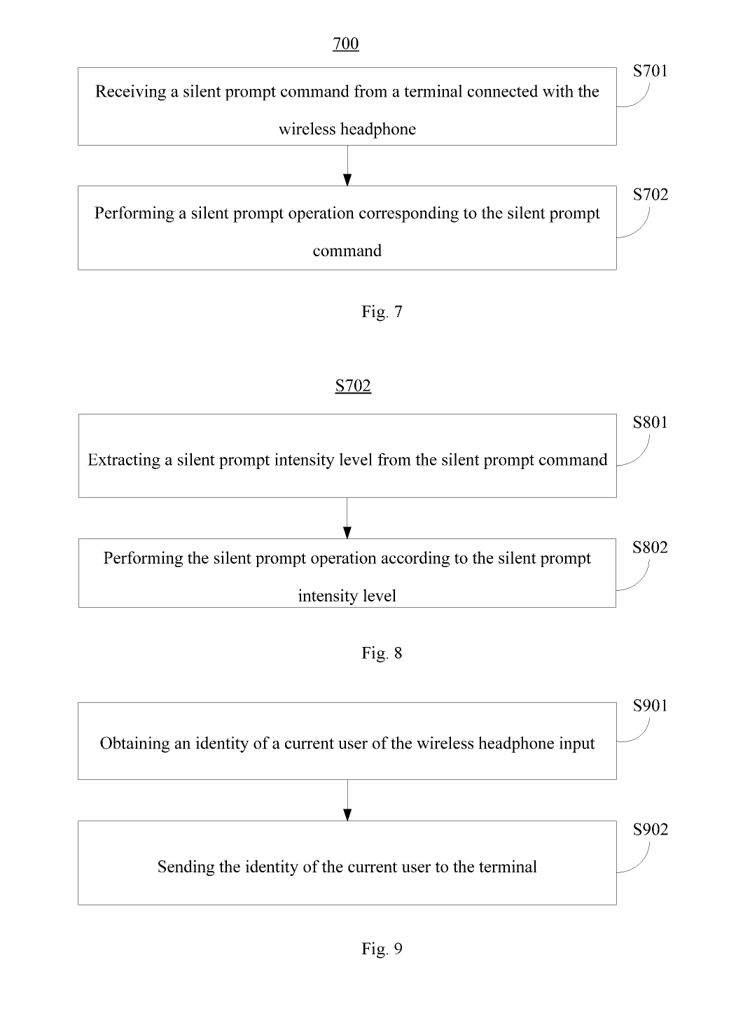

FIG. 7 is a flow chart showing an event prompting method 700 according to another exemplary embodiment. The method 700 can be implemented, for example, in a wireless headphone. As shown in FIG. 7, at S701, a silent prompt command from a terminal connected with the wireless headphone is received. At S702, a silent prompt operation corresponding to the silent prompt command is performed.

FIG. 8 shows an exemplary detailed process of S702 in FIG. 7. As shown in FIG. 8, at S801, a silent prompt intensity level is extracted from the silent prompt command. At S802, the silent prompt operation is performed according to the silent prompt intensity level.

FIG. 9 is a flow chart showing an identity obtaining method according to an exemplary embodiment. The identity obtaining method shown in FIG. 9 can be combined with exemplary methods described above, such as the exemplary method shown in FIG. 7 or FIG. 8. As shown in FIG. 9, at S901, an input identity of a current user of the wireless headphone is obtained. At S902, the identity of the current user is sent to the terminal.

That is, the wireless headphone can obtain input of the identity of the current user. In some embodiments, the identity of the current user can be obtained by one or more buttons or an interface provided on the wireless headphone. For example, the wireless headphone can include two buttons, with a first button corresponding to an identity of a predetermined user and a second button corresponding to an identity of a non-predetermined user. When the terminal receives the identity corresponding to one of the first and second buttons triggered by the user, the terminal can decide whether the current user is the predetermined user or the non-predetermined user.

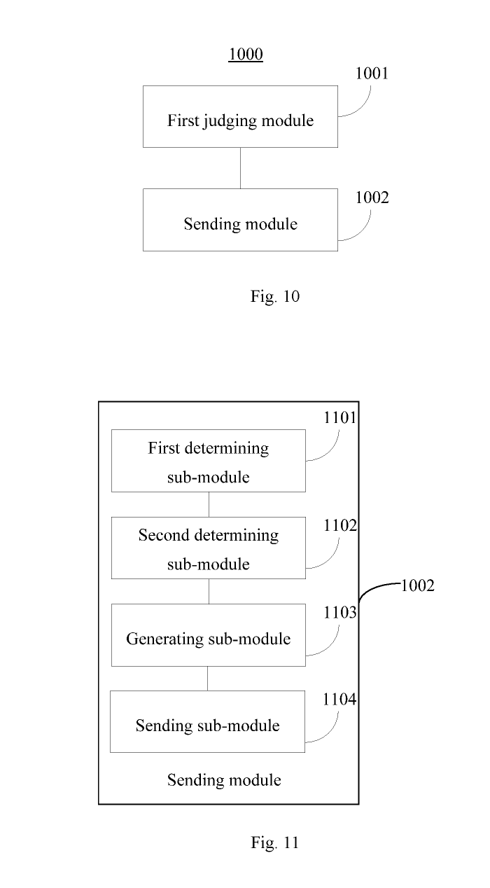

FIG. 10 is a block diagram showing an event prompting device 1000 according to an exemplary embodiment. The device 1000 can be implemented, for example, as a part or entirety of a terminal via software, hardware, or a combination thereof. As shown in FIG. 10, the event prompting device 1000 includes a first judging module 1001 and a sending module 1002. The first judging module 1001 is configured to judge whether the terminal is playing predetermined audio information via a wireless headphone connected with the terminal when an event to be prompted is received. The sending module 1002 is configured to send a silent prompt command to the wireless headphone according to the event to be prompted if the terminal is playing the predetermined audio information via the wireless headphone connected with the terminal. The silent prompt command is configured to control the wireless headphone to perform a silent prompt operation.

FIG. 11 is a block diagram showing an example of the sending module 1002 consistent with the present disclosure. As shown in FIG. 11, the sending module 1002 includes a first determining sub-module 1101, a second determining sub-module 1102, a generating sub-module 1103, and a sending sub-module 1104. The first determining sub-module 1101 is configured to determine a type of the event to be prompted. The second determining sub-module 1102 is configured to determine a silent prompt intensity level corresponding to the type of the event to be prompted according to the type of the event and a predetermined correspondence between event types and silent prompt intensity levels. The generating sub-module 1103 is configured to generate the silent prompt command according to the silent prompt intensity level. The sending sub-module 1104 is configured to send the silent prompt command to the wireless headphone. The wireless headphone is configured to perform the silent prompt operation according to the silent prompt intensity level in the silent prompt command.

In some embodiments, the first determining sub-module 1101 is further configured to obtain an application to which the event to be prompted belongs and determine the type of the event to be prompted according to the application.

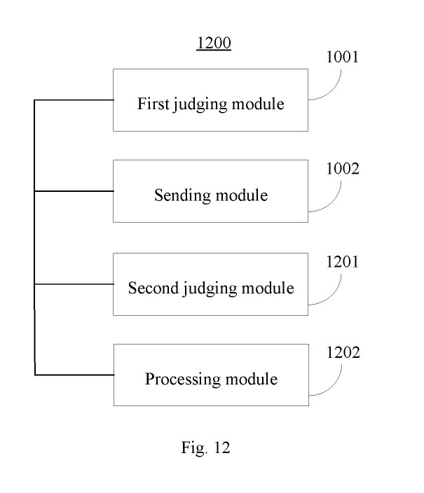

FIG. 12 is a block diagram showing another example of the event prompting device 1200 consistent with the present disclosure. The device 1200 is similar to the device 1000, except that the device 1200 further includes a second judging module 1201 and a processing module 1202. The second judging module 1201 is configured to judge whether a current user of the wireless headphone is a predetermined user before the silent prompt command is sent to the wireless headphone according to the event to be prompted. The processing module 1202 is configured to trigger the sending module 1002 if the current user is the predetermined user and not to trigger the sending module 1002 if the current user is not the predetermined user.

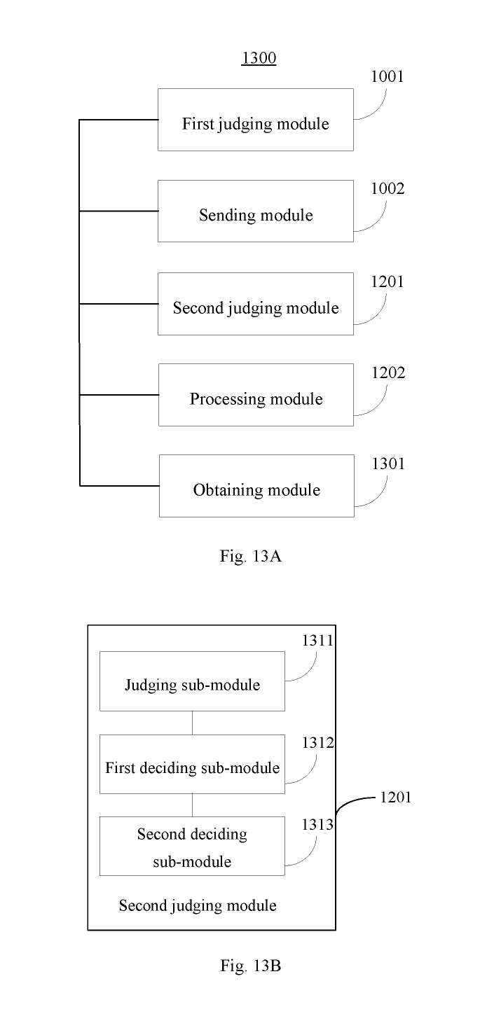

FIG. 13A is a block diagram showing an event prompting device 1300 according to another exemplary embodiment. The device 1300 is similar to the device 1200, except that the device 1300 further includes an obtaining module 1301 configured to obtain an identity of the current user of the wireless headphone before the silent prompt command is sent to the wireless headphone according to the event to be prompted.

FIG. 13B is a block diagram showing an example of the second judging module 1201 consistent with the present disclosure. As shown in FIG. 13B, the second judging module 1201 includes a judging sub-module 1311, a first deciding sub-module 1312, and a second deciding sub-module 1313. The judging sub-module 1311 is configured to judge whether the identity of the current user matches a predetermined user identity. The first deciding sub-module 1312 is configured to decide that the current user is the predetermined user if the identity of the current user matches the predetermined user identity. The second deciding sub-module 1313 is configured to decide that the current user is not the predetermined user if the identity of the current user does not match the predetermined user identity.

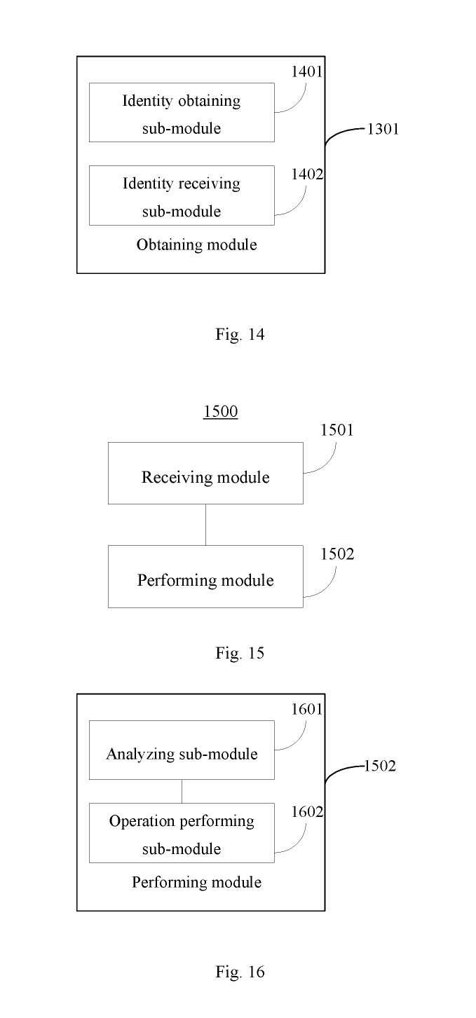

FIG. 14 is a block diagram showing an example of the obtaining module 1301 consistent with the present disclosure. As shown in FIG. 14, the obtaining module 1301 includes an identity obtaining sub-module 1401 configured to obtain an input of the identity of the current user or an identity receiving sub-module 1402 configured to receive the identity of the current user from the wireless headphone.

FIG. 15 is a block diagram showing an event prompting device 1500 according to another exemplary embodiment. The device 1500 can be implemented, for example, as a part or entirety of a wireless headphone via software, hardware, or a combination thereof. As shown in FIG. 15, the event prompting device 1500 includes a receiving module 1501 and a performing module 1502. The receiving module 1501 is configured to receive a silent prompt command from a terminal connected with the wireless headphone. The performing module 1502 is configured to perform a silent prompt operation corresponding to the silent prompt command.

FIG. 16 is a block diagram showing an example of the performing module 1502 consistent with the present disclosure. As shown in FIG. 16, the performing module 1502 includes an analyzing sub-module 1601 and an operation performing sub-module 1602. The analyzing sub-module 1601 is configured to analyze a silent prompt intensity level in the silent prompt command. The operation performing sub-module 1602 is configured to perform the silent prompt operation according to the silent prompt intensity level.

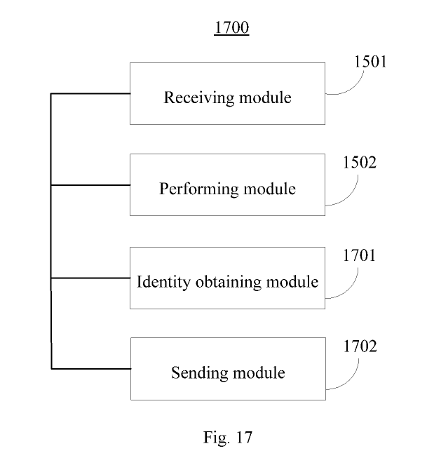

FIG. 17 is a block diagram showing an event prompting device 1700 according to another exemplary embodiment. The device 1700 is similar to the device 1500, except that the device 1700 further includes an identity obtaining module 1701 configured to obtain an identity of a current user of the wireless headphone input and a sending module 1702 configured to send the identity of the current user to the terminal.

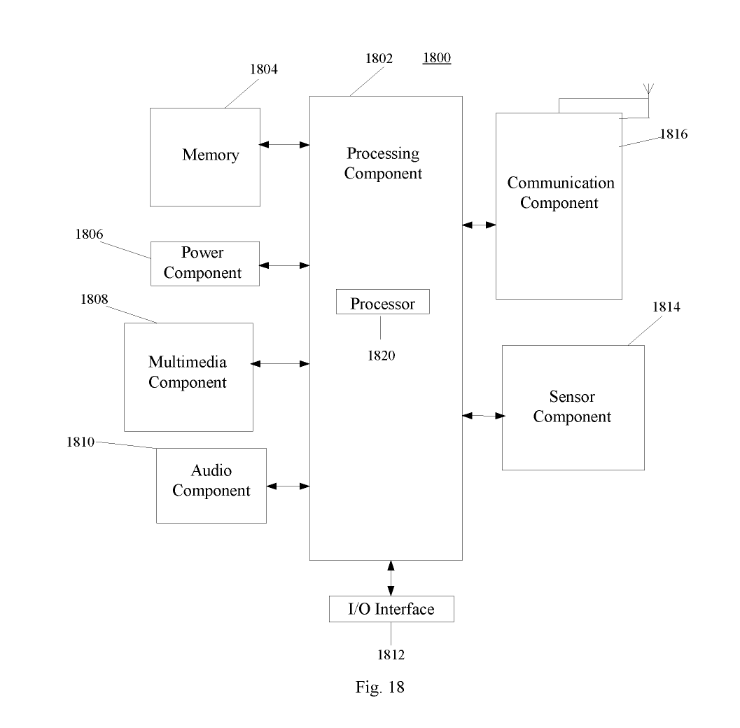

FIG. 18 is a block diagram of an event prompting device 1800 according to another exemplary embodiment. The device 1800 can be implemented, for example, in or as a terminal. For example, the device 1800 may be a mobile phone, a computer, a digital broadcast terminal, a message receiving and sending device, a gaming console, a tablet device, a medical device, exercise equipment, a personal digital assistant, or the like.

The device 1800 includes one or more of the following components: a processing component 1802, a memory 1804, a power component 1806, a multimedia component 1808, an audio component 1810, an input/output (I/O) interface 1812, a sensor component 1814, and a communication component 1816.

The processing component 1802 typically controls overall operations of the device 1800, such as the operations associated with display, telephone calls, data communications, camera operations, and recording operations. The processing component 1802 may include one or more processors 1820 to execute instructions to perform all or part of a method consistent with embodiments of the present disclosure, such as one of the above described methods. Moreover, the processing component 1802 may include one or more modules which facilitate the interaction between the processing component 1802 and other components. For instance, the processing component 1802 may include a multimedia module to facilitate the interaction between the multimedia component 1808 and the processing component 1802.

The memory 1804 is configured to store various types of data to support the operation of the device 1800. Examples of such data include instructions for any applications or methods operated on the device 1800, contact data, phonebook data, messages, pictures, video, etc. The memory 1804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1806 provides power to various components of the device 1800. The power component 1806 may include a power management system, one or more power sources, and any other components associated with the generation, management, and distribution of power in the device 1800.

The multimedia component 1808 includes a screen providing an output interface between the device 1800 and the user. In some embodiments, the screen may include a liquid crystal display (LCD) and a touch panel. If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1808 includes a front camera and/or a rear camera. The front camera and/or the rear camera may receive an external multimedia datum while the device 1800 is in an operation mode, such as a photographing mode or a video mode. Each of the front camera and the rear camera may be a fixed optical lens system or have focus and optical zoom capability.

The audio component 1810 is configured to output and/or input audio signals. For example, the audio component 1810 includes a microphone configured to receive an external audio signal when the device 1800 is in an operation mode, such as a call mode, a recording mode, and a voice recognition mode. The received audio signal may be further stored in the memory 1804 or transmitted via the communication component 1816. In some embodiments, the audio component 1810 further includes a speaker to output audio signals.

The I/O interface 1812 provides an interface between the processing component 1802 and peripheral interface modules, such as a keyboard, a click wheel, buttons, and the like. The buttons may include, but are not limited to, a home button, a volume button, a starting button, and a locking button.

The sensor component 1814 includes one or more sensors to provide status assessments of various aspects of the device 1800. For instance, the sensor component 1814 may detect an open/closed status of the device 1800, relative positioning of components, e.g., the display and the keypad, of the device 1800, a change in position of the device 1800 or a component of the device 1800, a presence or absence of user contact with the device 1800, an orientation or an acceleration/deceleration of the device 1800, and a change in temperature of the device 1800. The sensor component 1814 may include a proximity sensor configured to detect the presence of nearby objects without any physical contact. The sensor component 1814 may also include a light sensor, such as a CMOS or CCD image sensor, for use in imaging applications. In some embodiments, the sensor component 1814 may also include an accelerometer sensor, a gyroscope sensor, a magnetic sensor, a pressure sensor, or a temperature sensor.

The communication component 1816 is configured to facilitate communication, wired or wirelessly, between the device 1800 and other devices. The device 1800 can access a wireless network based on a communication standard, such as WiFi, 2G, 3G, or 4G, or a combination thereof. In one illustrative embodiment, the communication component 1816 receives a broadcast signal or broadcast associated information from an external broadcast management system via a broadcast channel. In one illustrative embodiment, the communication component 1816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In some embodiments, the device 1800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing a method consistent with the present disclosure, such as one of the above described methods.

In some embodiments, there is also provided a non-transitory computer-readable storage medium including instructions, such as included in the memory 1804, executable by the processor 1820 in the device 1800, for performing a method consistent with the present disclosure, such as one of the above-described methods. For example, the non-transitory computer-readable storage medium may be a ROM, a RAM, a CD-ROM, a magnetic tape, a floppy disc, an optical data storage device, or the like.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as illustrative only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

What is claimed is:

1. An event prompting method for use in a terminal, comprising:
judging, when an event to be prompted is received, whether the terminal is playing predetermined audio information via a wireless headphone connected with the terminal; and
sending, if the terminal is playing the predetermined audio information, a silent prompt command to the wireless headphone according to the event to be prompted, the silent prompt command being configured to control the wireless headphone to perform a silent prompt operation.

2. The method of claim 1, wherein sending the silent prompt command to the wireless headphone according to the event to be prompted includes:
determining a type of the event to be prompted;
determining a silent prompt intensity level corresponding to the type of the event to be prompted according to a predetermined correspondence between types of events and silent prompt intensity levels;
generating the silent prompt command according to the silent prompt intensity level; and
sending the silent prompt command to the wireless headphone.

3. The method of claim 2, wherein determining the type of the event to be prompted includes:
obtaining an application to which the event to be prompted belongs; and
determining the type of the event to be prompted according to the application.

4. The method of claim 1, further comprising, before sending the silent prompt command:
judging whether a current user of the wireless headphone is a predetermined user; and
sending the silent prompt command if the current user is the predetermined user; or not sending the silent prompt command if the current user is not the predetermined user.

5. The method of claim 4, further comprising, before sending the silent prompt command:
obtaining an identity of the current user of the wireless headphone,
wherein judging whether the current user of the wireless headphone is the predetermined user includes:
judging whether the identity of the current user matches a predetermined user identity; and
deciding that the current user is the predetermined user if the identity of the current user matches the predetermined user identity; or
deciding that the current user is not the predetermined user if the identity of the current user does not match the predetermined user identity.

6. The method of claim 5, wherein obtaining the identity of the current user of the wireless headphone includes:
obtaining an input of the identity of the current user; or
receiving the identity of the current user from the wireless headphone.

7. An event prompting method for use in a wireless headphone, comprising:
receiving a silent prompt command from a terminal connected with the wireless headphone; and
performing a silent prompt operation corresponding to the silent prompt command.

8. The method of claim 7, wherein performing the silent prompt operation corresponding to the silent prompt command includes:
analyzing a silent prompt intensity level in the silent prompt command; and
performing the silent prompt operation according to the silent prompt intensity level.

9. The method of claim 8, wherein performing the silent prompt operation includes performing at least one of a vibration prompt operation or a light flashing prompt operation.

10. The method of claim 7, further comprising:
obtaining an identity of a current user of the wireless headphone input; and
sending the identity of the current user to the terminal.

11. The method of claim 10, wherein performing the silent prompt operation includes performing at least one of a vibration prompt operation or a light flashing prompt operation.

12. The method of claim 7, wherein performing the silent prompt operation includes performing at least one of a vibration prompt operation or a light flashing prompt operation.

13. A terminal, comprising:
a processor; and
a memory storing instructions that, when executed by the processor, cause the processor to:
judge, when an event to be prompted is received, whether the terminal is playing predetermined audio information via a wireless headphone connected with the terminal; and
send, if the terminal is playing the predetermined audio information, a silent prompt command to the wireless headphone according to the event to be prompted, the silent prompt command being configured to control the wireless headphone to perform a silent prompt operation.

14. The event prompting device of claim 13, wherein the instructions further cause the processor to send the silent prompt command to the wireless headphone according to the event to be prompted by:
determining a type of the event to be prompted;
determining a silent prompt intensity level corresponding to the type of the event to be prompted according to a predetermined correspondence between types of events and silent prompt intensity levels;
generating the silent prompt command according to the silent prompt intensity level; and
sending the silent prompt command to the wireless headphone.

15. The event prompting device of claim 14, wherein the instructions further cause the processor to determine the type of the event to be prompted by:
obtaining an application to which the event to be prompted belongs; and
determining the type of the event to be prompted according to the application.

16. The event prompting device of claim 13, wherein the instructions further cause the process to, before sending the silent prompt command:
judge whether a current user of the wireless headphone is a predetermined user; and
send the silent prompt command if the current user is the predetermined user; or
not send the silent prompt command if the current user is not the predetermined user.

17. The event prompting device of claim 16, wherein the instructions further cause the processor to, before sending the silent prompt command:
obtain an identity of the current user of the wireless headphone;
judge whether the identity of the current user matches a predetermined user identity; and
decide that the current user is the predetermined user if the identity of the current user matches the predetermined user identity; or
decide that the current user is not the predetermined user if the identity of the current user does not match the predetermined user identity.

18. The event prompting device of claim 17, wherein the instructions further cause the processor to obtain the identity of the current user of the wireless headphone by:
obtaining an input of the identity of the current user; or
receiving the identity of the current user from the wireless headphone.
